(19) United States
(12) Patent Application Publication
(10) Pub. No.: US 2011/0001417 A1
(43) Pub. Date: Jan. 6, 2011

(54) LED bulb with heat removal device

(76) Inventor: Albert Stekelenburg, Taipei (TW)

Correspondence Address: Guice Patents PLLC, 12647 Galveston Court #302, Manassas, VA, 20112, US

(21) Appl. No.: 12/007,811

(22) Filed: Jan. 15, 2008

(51) Int. Cl. H01J 61/52

(52) U.S. Cl. 313/46

(57) ABSTRACT

A LED bulb includes a housing having a base mounted in an electrical socket; a heat removal device mounted on a lower portion of the housing for surrounding the remaining portion of the housing; a bulb formed of transparent material or being frosted, the bulb being mounted on a top edge of the heat removal device; a light source (e.g., Hi-Power LED) mounted on the heat removal device and the housing; and a circuit board received in the housing, the circuit board being electrically connected to the light source and the base respectively. Heat generated by the LED is adapted to conduct away by the heat removal device. In one embodiment, the heat removal device includes an inverted, truncated cone having a corrugated surface. In another embodiment, the cone includes a plurality of longitudinal, spaced latches formed around, the latches having an opening.

### BACKGROUND OF THE INVENTION

1. Field of Invention

The invention relates to light sources and more particularly to an LED (light-emitting diode) having a heat removal device for sufficiently dissipating excess heat generated by a high power (“Hi-Power”) LED.

2. Description of Related Art

LED lamps have advantages including longer life, less power consumption (i.e., more energy-efficient), and no special ballasts being required. Thus, LED based light sources have gradually replace conventional incandescent lamps and fluorescent lamps as an ideal light source.

One type of LED lamp has a Hi-Power LED as light source. However, excess heat can be generated by the Hi-Power LED. Hence, such LED lamps are limited in applications (e.g., in indoor environment). Hence, a need has arisen for an improved LED lamp having a heat removal device for dissipating excess heat generated by the Hi-Power LED so that the LED lamp can find applications in indoor environment.

There have been numerous suggestions in prior patents for LED based light sources. For example, U.S. Pat. No. 5,688,042 discloses an LED lamp and U.S. Pat. No. 7,086,767 discloses an LED bulb.

### SUMMARY OF THE INVENTION

It is therefore one object of the invention to provide an LED bulb including a metal heat removal device mounted between a bulb and a housing, and a Hi-Power LED being in good thermal contact with the heat removal device such that excess heat generated by the Hi-Power LED can be sufficiently dissipated.

In one aspect of the invention the heat removal device comprises an outer, inverted, truncated cone and a top mounting member secured to the bulb, the mounting member being integrally formed with the cone by die casting.

In another aspect of the invention the heat removal device comprises an outer, inverted, truncated cone and a top mounting member secured to the bulb, the mounting member being formed separately prior to assembling with the cone.

In yet another aspect of the invention the cone comprises a plurality of longitudinal heat radiating grooves so as to provide a large heat radiating surface.

In a further aspect of the invention the heat radiating grooves have openings so as to provide a large heat radiating surface and space.

The above and other objects, features and advantages of the invention will become apparent from the following detailed description taken with the accompanying drawings.

### BRIEF DESCRIPTION OF THE DRAWINGS

FIG. 1 is a side elevation of an LED bulb incorporating a first preferred embodiment of heat removal device according to the invention;

FIG. 2 is a longitudinal sectional view of the LED bulb of FIG. 1;

FIG. 3 is an exploded view of the LED bulb of FIG. 1; and

FIG. 4 is a perspective view of a second preferred embodiment of heat removal device according to the invention.

### DETAILED DESCRIPTION OF THE INVENTION

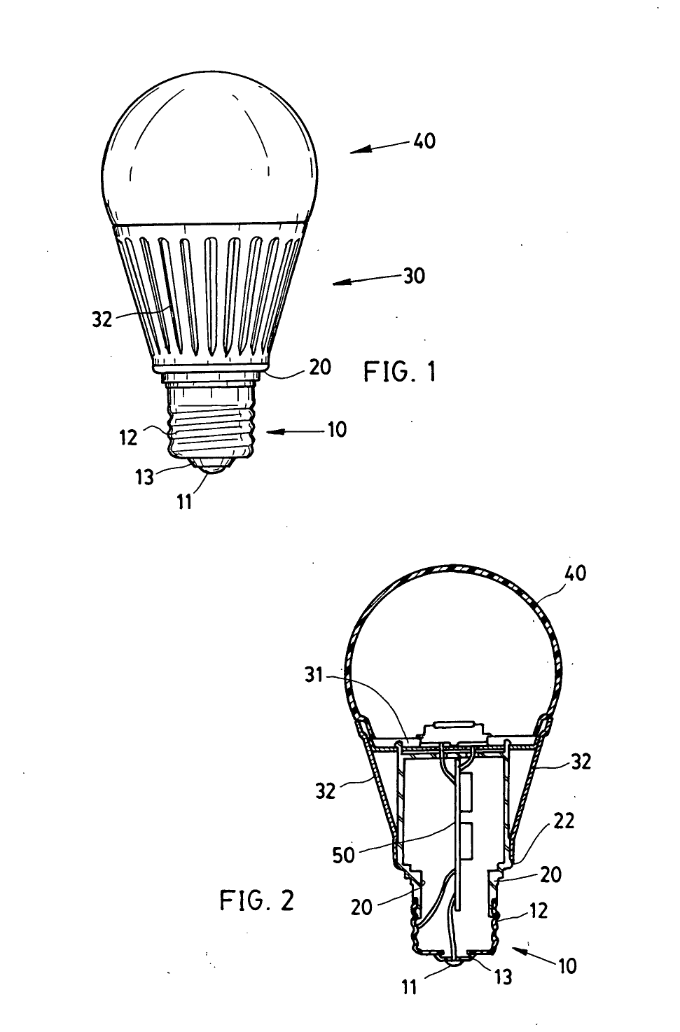

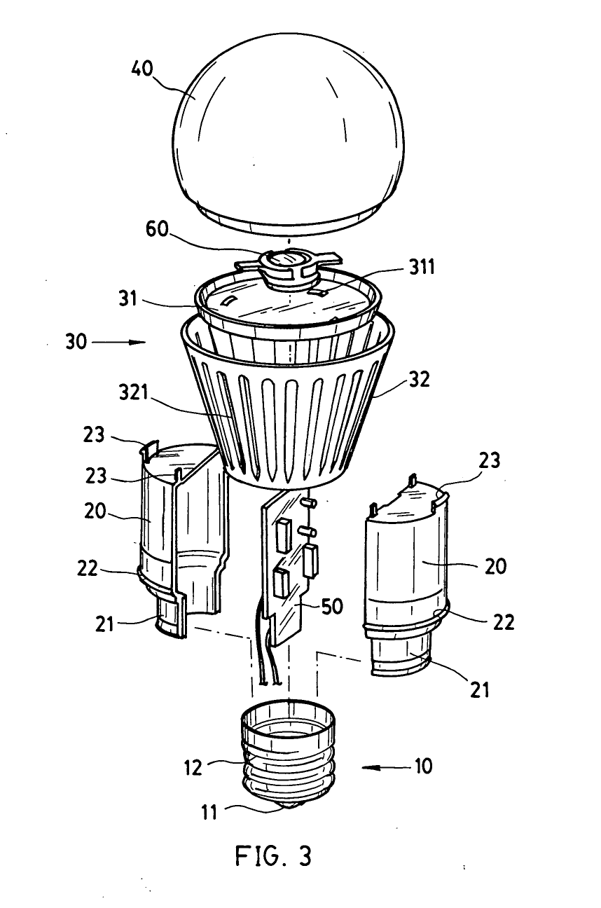

Referring to FIGS. 1 to 3, an LED bulb in accordance with the invention is shown. The LED bulb comprises a base 10, a housing 20, a heat removal device 30, a bulb 40, a printed circuit board (PCB) 50, and a solid state light source 60. Each component is discussed in detail below.

The base 10 is a well known device and is adapted to mount in an electrical socket. The base 10 comprises a bottom contact 11 being used as, for example, positive terminal, a metallic element 12 formed of copper, the metallic element 12 being used as, for example, negative terminal, and an insulator 13 formed between the contact 11 and the metallic element 12 for preventing them from electrically contacting each other.

The hollow, cylindrical housing 20 is adapted to mount on the base 10. The housing 20 consists of two mated halves. The housing 20 is formed of an insulative material and comprises a lower portion 21 of reduced diameter adapted to secure to an upper portion of the base 10, an annular flange 22 formed between the lower portion 21 and an upper main portion of the housing 20, and a plurality of top tabs 23. The insulative housing 20 is mounted between the heat removal device 30 and the metallic element 12 for preventing them from electrically contacting each other.

The PCB 50 is fastened in the housing 20. The PCB 50 comprises electrical elements such as capacitors, resistors, diodes, etc. The PCB 50 has two conductors (not numbered) electrically connected to the contact 11 and the metallic element 12 respectively.

The heat removal device 30 is formed of good conductive material (e.g., metal) and comprises an inverted, truncated cone 32 surrounding most portion of the housing 20 and having its bottom edge rested upon and secured to the flange 22, the cone 32 including a plurality of longitudinal, spaced heat radiating grooves 321 formed around the outer surface, the heat radiating grooves 321 substantially having one end adjacent the top edge of the cone 32 and the other end adjacent the bottom edge of the cone 32 such that the heat radiating grooves 321 can provide a large heat radiating surface, and a disc-shaped mounting member 31 secured to a top edge of the cone 32, the mounting member 31 including a plurality of holes 311 secured to the tabs 23 by snapping the tabs 23 through the holes 311 with the light source 60 on the mounting member 31 being surrounded by the holes 311. Further, the light source 60 is electrically connect to the PCB 50.

The bulb 40 is made of transparent material (e.g., glass) as to be clear or frosted to diffuse the light. The bulb 40 is mounted on the top edge of the heat removal device 30 so as together with the heat removal device 30, the housing 20, and the base 10 to sealingly receive the PCB 50 and the light source 60.

The light source 60 is implemented as an LED (e.g., Hi-Power LED in this embodiment). Alternatively, the light source 60 is formed of another material in other embodiments.

Heat generated by the light source 60 can be effectively conducted away by the heat removal device 30 (i.e., through the mounting member 31 and the heat radiating grooves 321 of the cone 32).

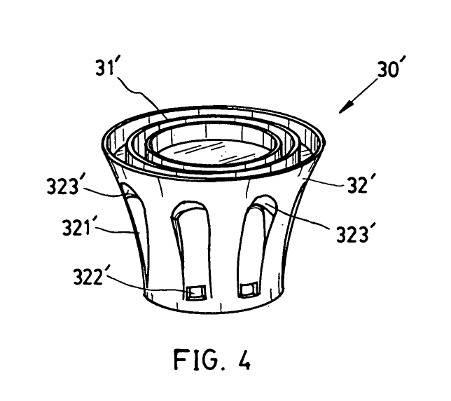

Referring to FIG. 4, a heat removal device 30′ according to a second preferred embodiment of the invention is shown. The characteristics of the second preferred embodiment are detailed below. The mounting member 31′ is integrally formed with the cone 32′ by die casting. Further, the heat radiating grooves 321 are replaced by latches 321′ having an open top end 323′ and a lower opening 322′ so as to provide a large heat radiating surface and space.

While the invention herein disclosed has been described by means of specific embodiments, numerous modifications and variations could be made thereto by those skilled in the art without departing from the scope and spirit of the invention set forth in the claims.

What is claimed is:

1. An LED light source comprising:
a housing having a base adapted to mount in an electrical socket;
heat removal means formed of conductive material and mounted on a lower portion of the housing for surrounding the remaining portion of the housing;
a bulb formed of transparent material or being frosted, the bulb being mounted on a top edge of the heat removal means;
a light source mounted on the heat removal means and the housing, the light source being adapted to emit light to pass the bulb; and
a circuit board received in the housing, the circuit board being electrically connected to the light source and the base respectively,
wherein heat generated by the light source is adapted to conduct away by the heat removal means.

2. The LED light source of claim 1, wherein the light source is an LED.

3. The LED light source of claim 1, wherein the light source is a Hi-Power LED.

4. The LED light source of claim 1, wherein the heat removal means is an integral member.

5. The LED light source of claim 1, wherein the heat removal means comprises an inverted, truncated cone and a disc-shaped mounting member secured to the top of the cone with the light source secured thereon such that heat generated by the light source is adapted to conduct away through the mounting member and the cone.

6. The LED light source of claim 5, wherein the cone includes a plurality of longitudinal, spaced heat radiating grooves formed around.

7. The LED light source of claim 5, wherein the cone includes a plurality of longitudinal, spaced latches formed around, the latches having an opening.
